(19) United States
(12) Patent Application Publication
(10) Pub. No.: US 2026/0228137 A1
(43) Pub. Date: Aug. 6, 2026

(54) TAG PROTECTING INSTRUCTION

(71) Applicant: Arm Limited, Cambridge (GB)

(72) Inventor: Graeme Peter Barnes, Cambridge (GB)

(73) Assignee: Arm Limited, Cambridge (GB)

(21) Appl. No.: 19/157,493

(22) PCT Filed: Jan. 8, 2024
(86) PCT No.: PCT/GB2024/050029

§ 371 Date: Aug. 18, 2025

(30) Foreign Application Priority Data
Feb. 24, 2023 (GB) 2302689.1

(51) Int. Cl. G06F 12/14; G06F 11/07; G06F 21/54

(52) U.S. Cl. CPC G06F 12/1483; G06F 11/0772; G06F 21/54

(57) ABSTRACT

Access control circuitry (15), responsive to a memory access request, compares a tag value determined based on a tag portion (40) of an address pointer (42) with an allocation tag (32) associated with the memory location identified by a memory address determined from the address pointer. In response to the comparison indicating a given result, a tag error response is performed. Processing circuitry (4), executing a tag protecting instruction, detects whether an operation involves an attempt to set a bit in an identified portion (74) of an output value to a value other than that in a corresponding bit in an input operand. The processing circuitry sets, when it detects said attempt, a given portion of the output value to an error-indicating value. The identified portion is a portion of the output value which would be used as the tag portion if the output operand was used as the address pointer for a memory access instruction.

The present technique relates to the field of data processing.

Software to be executed by a data processing apparatus may typically be written in a high-level programing language and then compiled into code according to the instruction set architecture supported by the apparatus on which the software is to be executed. For example, the software may originally be written in a higher level language such as Java, C or C++, and then compiled into a natively supported instruction set architecture such as x86 or Arm®.

Some higher level programming languages, such as Java, are considered memory-safe languages because they include run time error detection checks for checking for certain errors relating to memory accesses. In contrast, memory-unsafe languages, such as C and C++, do not include such run time error checks. The enduring prevalence of use of memory-unsafe languages means that in compiled code according to a given instruction set architecture, there may be a large number of memory related errors which may be vulnerable to exploitation by an attacker or other malicious party. Such errors may include:
Bounds violations, in which an array index supplied by the code is outside the legitimate bounds of the array;
Use-after-free errors, in which an access to a memory location is made after that memory location has already be deallocated or freed;
Use-after-return, in which a memory access to an address associated with a variable used within a function (such as a value on a stack) is made after already returning from the function;
Use-out-of-scope errors, in which variables are accessed outside of the scope in which they are declared; and
Use-before-initialisation errors, in which a memory address associated with a variable is accessed before the variable has been initialised.

These are just some examples of memory-related errors which can result in unpredictable behaviour and potentially provide avenues for attackers to exploit. Hence, it may be desirable to provide architectural support, within the instruction set architecture supported by a given processing apparatus, for assisting with runtime detection of certain classes of memory errors.

One approach for protecting against certain memory usage errors of the type discussed above may be to provide guard tags which are stored in a memory system in association with blocks of one or more memory locations. When a tag-guarded memory access operation is requested based on a target address identifying a particular addressed location in the memory system, memory access circuitry may compare an address tag that is associated with the target address with a guard tag that is stored in the memory system in association with a block of one or more memory locations which includes the addressed location identified by the target address. The memory access circuitry may generate an indication of whether a match is detected between the guard tag and the address tag. This indication can be used to control whether the memory access is allowed to succeed or whether subsequent operations can succeed, or could merely be reported while allowing memory accesses to continue as normal.

This can be useful as, for example, a compiler compiling code based on a memory-unsafe language such as C or C++ can, when initialising regions of memory, set the guard tags of blocks of memory which the code is expected to access to particular values, and may associate the corresponding address tag values with the target addresses pointing to those blocks. If a memory usage error occurs, and for example the address pointer is used out of scope or extends out of the bounds of the valid range which was initialised, then it may be likely that the guard tag associated with the addressed location may not match the address tag associated with the target address, and then in this case the indication of whether a match is detected can be used to trigger some error handling response or error reporting mechanism. The particular response taken can depend on the particular needs of the software being executed or on the particular micro-architectural implementation of the architecture. Hence, even if the high level language does not have means for performing run time error checks in order to guard against memory access errors, the ISA used for the compiled code may include architectural features for performing such checks.

Note that, while the term “guard tag” is used above, the term “allocation tag” may be used instead.

Viewed from a first example of the present technique, there is provided an apparatus comprising:
processing circuitry to perform data processing operations in response to instructions,
wherein the processing circuitry is responsive to a memory access instruction identifying an address pointer to issue a memory access request comprising a request to access data stored at a memory location identified by a memory address determined based on an address portion of the address pointer; and
access control circuitry responsive to the memory access request to compare a tag value determined based on a tag portion of the address pointer with an allocation tag associated with the memory location identified by the memory address and, in response to the comparison indicating a given result, to perform a tag error response,
wherein:
the processing circuitry is responsive to a tag protecting instruction identifying an input operand to perform an operation in respect of the input operand to generate an output value;
the processing circuitry is configured to detect whether the operation involved an attempt to set the value of at least one bit in an identified portion of the output value to a value other than a value in a corresponding bit position in the input operand;
the processing circuitry is configured to set, in response to detecting that the operation involved the attempt to set the value of at least one bit in the identified portion of the output value to the value other than the value in a corresponding bit position in the input operand, at least a given portion of the output value to an error-indicating value; and
the identified portion is a portion of the output value which would be used as the tag portion if the output operand was used as the address pointer for the memory access instruction.

Viewed from a second example of the present technique, there is provided a method comprising:
performing data processing operations in response to instructions,
in response to a memory access instruction identifying an address pointer, issuing a memory access request comprising a request to access data stored at a memory location identified by a memory address determined based on an address portion of the address pointer;
in response to the memory access request, comparing a tag value determined based on a tag portion of the address pointer with an allocation tag associated with the memory location identified by the memory address and, in response to the comparison indicating a given result, performing a tag error response;
in response to a tag protecting instruction identifying an input operand, performing an operation in respect of the input operand to generate an output value;
detecting whether the operation involved an attempt to set the value of at least one bit in an identified portion of the output value to a value other than a value in a corresponding bit position in the input operand; and
in response to detecting that the operation involved the attempt to set the value of at least one bit in the identified portion of the output value to the value other than the value in a corresponding bit position in the input operand, setting at least a given portion of the output value to an error-indicating value,
wherein the identified portion is a portion of the output value which would be used as the tag portion if the output operand was used as the address pointer for the memory access instruction.

Viewed from a third example of the present technique, there is provided a computer program comprising instructions which, when executed by a host data processing apparatus, control the host data processing apparatus to provide an instruction execution environment for executing target program code, the computer program comprising:
processing program logic to perform data processing operations in response to instructions in the target program code,
wherein the processing program logic is responsive to a memory access instruction identifying an address pointer to issue a memory access request comprising a request to access data stored at a memory location identified by a memory address determined based on an address portion of the address pointer; and
access control program logic responsive to the memory access request to compare a tag value determined based on a tag portion of the address pointer with an allocation tag associated with the memory location identified by the memory address and, in response to the comparison indicating a given result, to perform a tag error response,
wherein:
the processing program logic is responsive to a tag protecting instruction identifying an input operand to perform an operation in respect of the input operand to generate an output value;
the processing program logic is configured to detect whether the operation involved an attempt to set the value of at least one bit in an identified portion of the output value to a value other than a value in a corresponding bit position in the input operand;
the processing program logic is configured to set, in response to detecting that the operation involved the attempt to set the value of at least one bit in the identified portion of the output value to the value other than the value in a corresponding bit position in the input operand, at least a given portion of the output value to an error-indicating value; and
the identified portion is a portion of the output value which would be used as the tag portion if the output operand was used as the address pointer for the memory access instruction.

Viewed from a third example of the present technique, there is provided a computer-readable storage medium to store the computer program described above. The computer-readable storage medium may be transitory or non-transitory.

Further aspects, features and advantages of the present technique will be apparent from the following description of examples, which is to be read in conjunction with the accompanying drawings, in which:

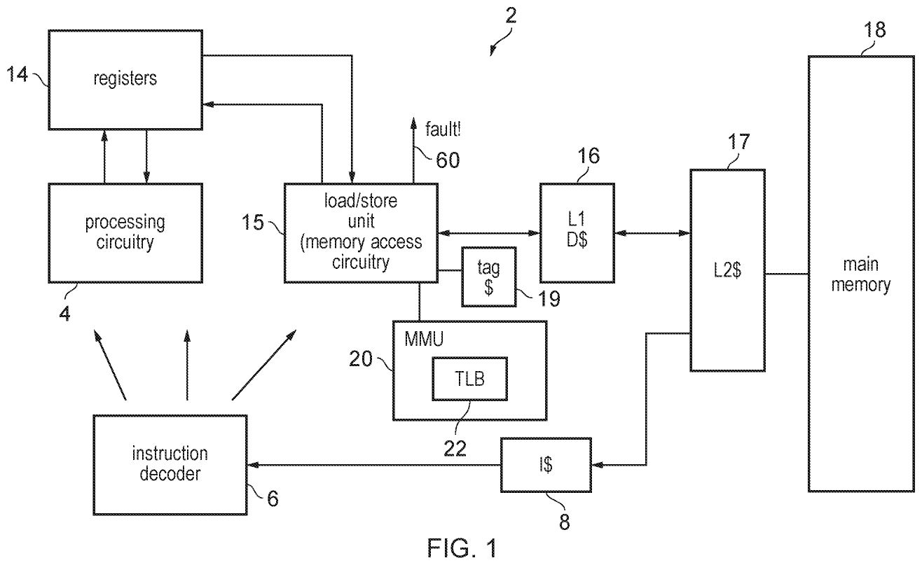

FIG. 1 schematically illustrates an example of a data processing apparatus;

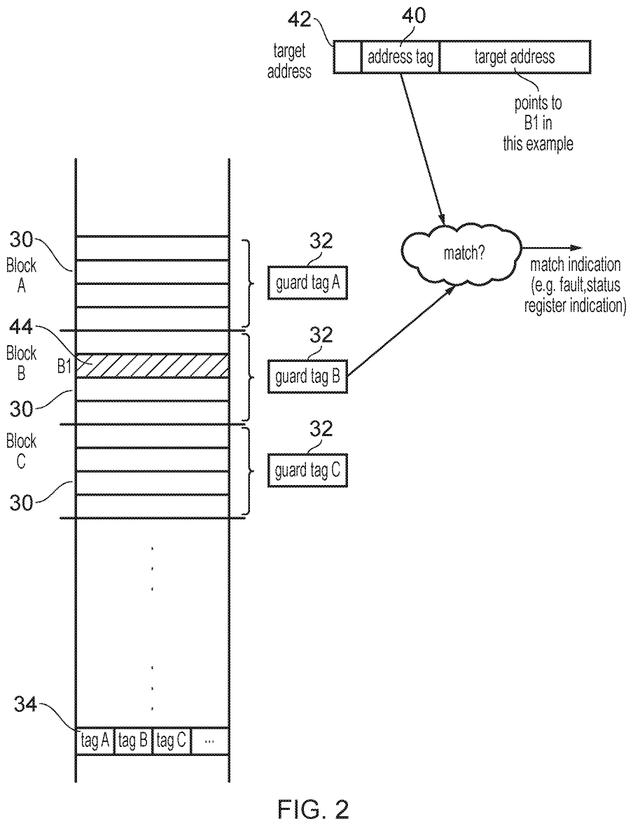

FIG. 2 shows an example of a tag-guarded memory access operation comprising checking whether an address tag matches a guard tag;

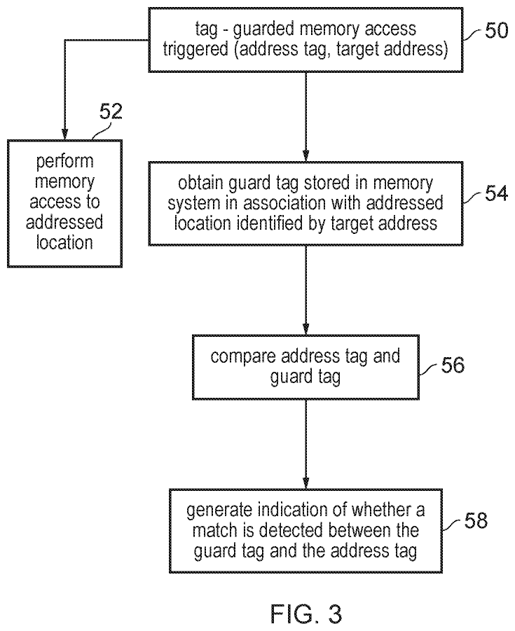

FIG. 3 is a flow diagram showing a method of performing a tag-guarded memory access operation;

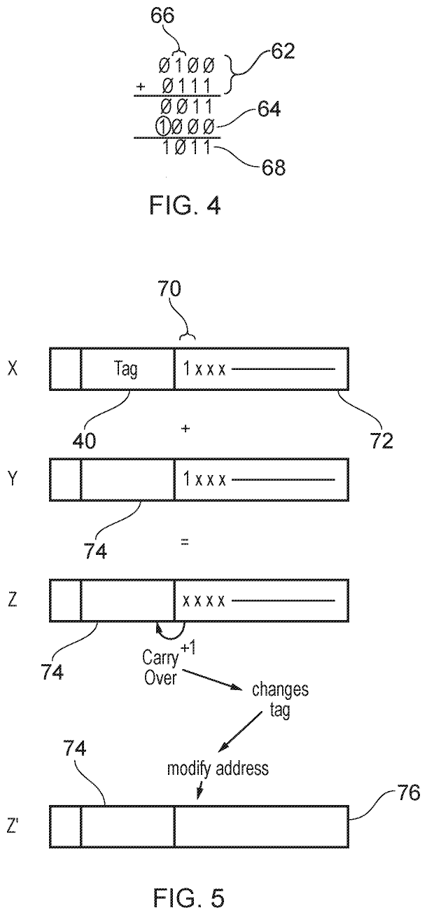

FIG. 4 illustrates an addition with a carry value;

FIG. 5 illustrates an example of how a tag protecting instruction may be executed;

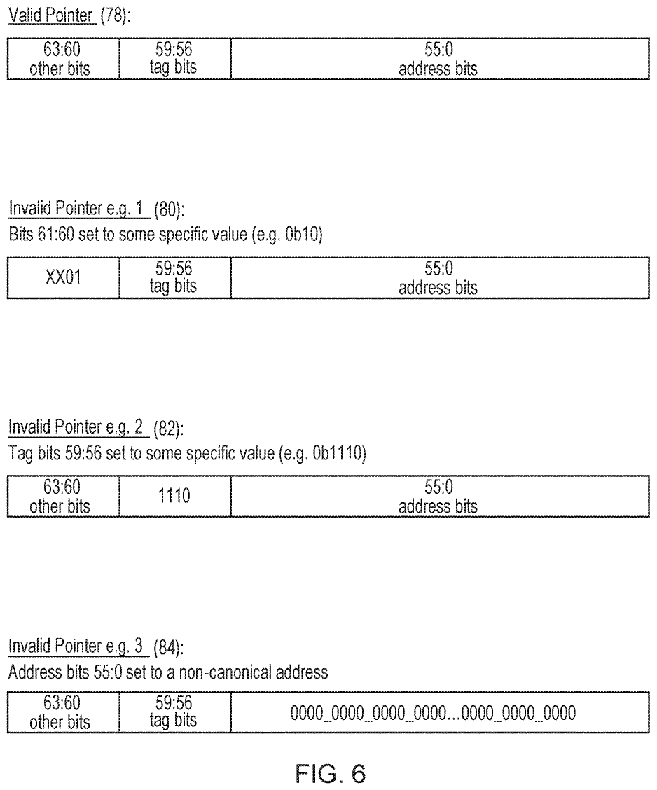

FIG. 6 illustrates examples of invalid address pointers;

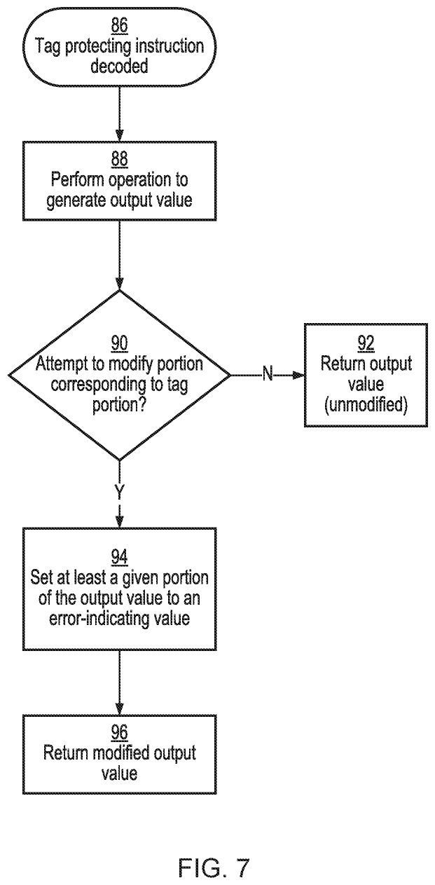

FIG. 7 is a flow diagram illustrating a method of executing a tag protecting instruction;

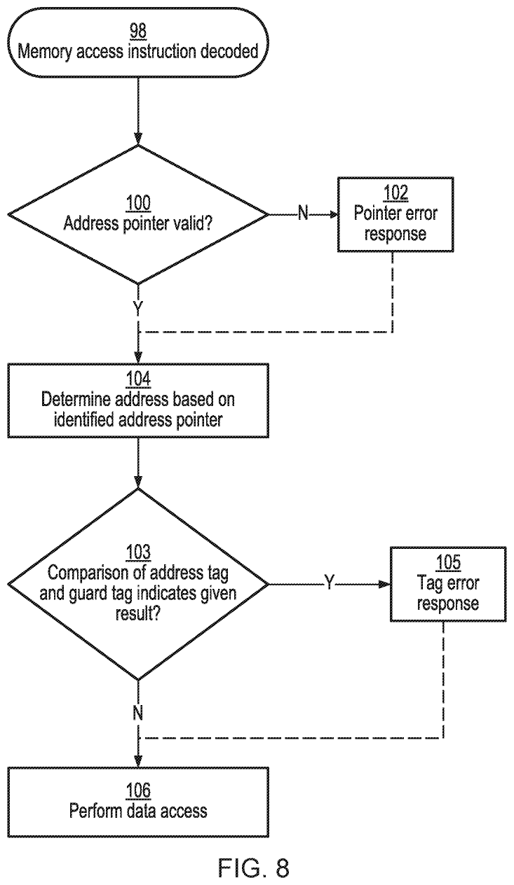

FIG. 8 is a flow diagram illustrating a method of executing a memory access instruction; and

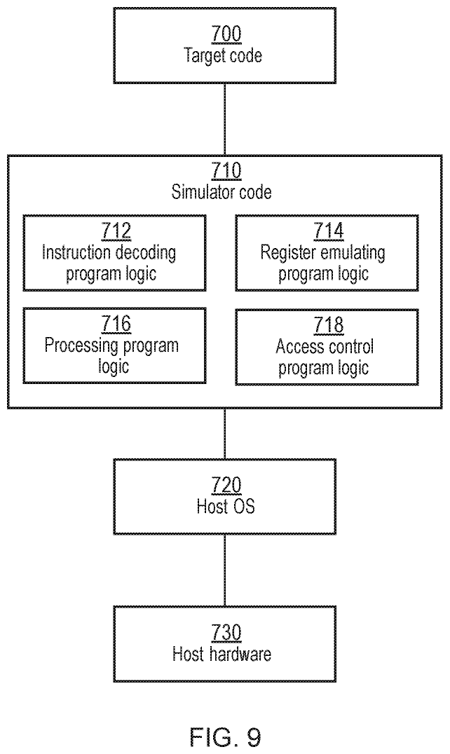

FIG. 9 illustrates a simulator implementation.

Before discussing example implementations with reference to the accompanying figures, the following description of example implementations and associated advantages is provided.

According to examples of the present technique, there is provided an apparatus comprising processing circuitry to perform data processing operations in response to instructions, wherein the processing circuitry is responsive to a memory access instruction identifying an address pointer to issue a memory access request comprising a request to access data stored at a memory location identified by a memory address determined based on an address portion of the address pointer. The apparatus also comprises access control circuitry responsive to the memory access request to compare a tag value determined based on a tag portion of the address pointer with an allocation tag associated with the memory location identified by the memory address and, in response to the comparison indicating a given result, to perform a tag error response.

The access control circuitry of the present technique may comprise the memory access circuitry described above, the tag value may comprise the address tag described above and the allocation tag may comprise the guard tag described above. Similarly, the tag error response may be performed in response to generation of an indication that a mismatch was detected between the guard tag and the address tag—the tag error response could, for example, involve preventing the memory access from succeeding (e.g. rejecting the memory access request and/or raising a processor exception), or could simply involve reporting the error while allowing the memory access to continue as normal. Accordingly, the apparatus of the present technique implements memory tagging.

In a system implementing memory tagging, tagged pointers may be manipulated as integers, which can lead to the tag value being modified. Modification of the tag can be problematic, as it can reduce the security benefits associated with memory tagging, by potentially making it possible for an attacker to manipulate the tag value.

To address these security concerns, the present technique provides a tag protecting instruction.

The processing circuitry is responsive to the tag protecting instruction, which identifies an input operand, to perform an operation in respect of the input operand to generate an output value. For example, the input operand identified by the tag protecting instruction may be an address pointer. However, the processing circuitry may be agnostic to the meaning of the input operand—e.g., the processing circuitry, when executing the tag protecting instruction, may treat the input operand as it would treat any other integer value. Note that the tag protecting instruction may identify more than one input operand.

The processing circuitry is configured to detect whether the operation (e.g. the operation performed in response to the tag protecting instruction) involved an attempt to set the value of at least one bit in an identified portion of the output value to a value other than a value in a corresponding bit position in the input operand, wherein the identified portion is a portion of the output value which would be used as the tag portion if the output operand was used as the address pointer for the memory access instruction

Hence, the tag protecting instruction provides a mechanism for detecting when an instruction attempts to modify the tag portion of an address pointer-whether this attempt was deliberate (e.g. an attacker inserting a tag-modifying instruction into the program code) or unintentional (e.g. an operation performed on another portion of the address pointer inadvertently affecting the tag portion).

In response to detecting that the operation involved the attempt to set the value of at least one bit in the identified portion of the output value to the value other than the value in a corresponding bit position in the input operand, the processing circuitry sets at least a given portion of the output value to an error-indicating value.

One might think that an appropriate response to detecting the attempt set the value of at least one bit in the identified portion of the output value to the value other than the value in a corresponding bit position in the input operand would be to raise an exception. However, there can be a significant performance cost associated with raising a processor exception, and this may not be justified in all cases. For example, the output operand may not ever be used as an address pointer, in which case the attempt to modify the identified portion may not be problematic. Hence, the inventor of the present technique has proposed an alternative response, which does not incur such a high performance cost. In particular, the processing circuitry of the present technique is responsive to the attempt to set a portion (e.g. some or all) of the output value to some error-indicating value. This makes it possible to detect, at a later stage, that the error occurred, without incurring the performance cost associated with raising an exception immediately.

The tag protecting instruction may be a dedicated instruction with an instruction encoding that indicates that it is to be executed as a tag protecting instruction—for example, there could be various tag protecting instructions provided in the instruction set architecture (ISA) for different operations that might be performed on input operands. However, given that the limited encoding space available for encoding new instructions, the processing circuitry may be capable of operating in any of a number of modes of operation, and certain instructions may be treated/decoded as tag protecting instructions in some modes but not in other modes. In other examples, all instructions of a given type (e.g. all arithmetic instructions) could be treated as tag protecting instructions. In any of these examples, there may be certain dedicated tag-setting instructions which may be permitted to modify the identified portion of the output value (e.g. these instructions may prevented from being executed as tag protecting instructions).

In some examples, the access control circuitry is responsive to the memory access instruction identifying, as the address pointer, an operand comprising the error-indicating value to trigger a pointer error response.

In this way, if there was an attempt to set the identified portion of the output value to a value different to that of the same portion of the input value, an error response can be triggered if the output value is subsequently used as an address pointer for a memory access. Performing this error response when and if the output value is used as an address pointer, rather than at the time of executing the tag protecting instruction, protects the memory system while reducing the likelihood of a “false positive” occurring (e.g. performing an error response even if the output value is never to be used as an address pointer), which in turn can improve performance.

In some examples, the processing circuitry is configured to detect whether the operand identified by the memory access instruction comprises the error-indicating value in dependence on at least one of:
a current mode of operation of the processing circuitry;
the operand; and
a value generated using at least part of the operand.

The processing circuitry can be arranged to operate in one of a plurality of modes of operation, with the current mode of operation of the processing circuitry may be indicated by a mode-indicating value stored in storage circuitry (e.g. a register) accessible to the processing circuitry. In some examples, the processing circuitry may detect or respond to the error-indicating value in different ways, depending on the current mode of operation. This could involve performing different error responses in different modes of operation. Moreover, the detection of the error-indicating value could be based on the operand itself, or based on some value (e.g. a hash) generated using at least part of the operand.

In some examples, the pointer error response comprises at least one of:
generating an exception; and
recording an error indication in a status register.

The pointer error response may be the same as or different to the tag error response discussed above.

There are a number of possibilities for which part of the output value is the given portion that is set to the error indicting value when the attempt to modify the identified portion is detected. In some examples, the given portion comprises the identified portion. For example, the identified portion could be set to a value which does not indicate a valid tag (and which would, therefore, trigger the tag error response if the output value were used as an address pointer).

In some examples, the given portion comprises an address-identifying portion, and the processing circuitry is responsive to the memory access instruction identifying, as the address pointer, the output value to treat the address-identifying portion of the output value as the address portion. For example, the address-indicating portion may be set to a non-canonical value (e.g. a value which does not identify a valid address) as the error-indicating value.

In some examples, the given portion of the output address pointer comprises an error indicating field of the output value. For example, there may be a portion of the output value which is reserved for indicating errors. For example, the error identifying field could be one or more bits in the output value which are not typically used for another purpose.

Note that, in some examples, the processing circuitry may set multiple portions of the output value to an error indicating value.

In some examples, the processing circuitry is configured to set the value of the given portion of the output value in dependence on at least one of:
a current mode of operation of the processing circuitry;
the input operand; and
the output value.

For example, the processing circuitry may set different portions of the output value to the error indicating value, depending on one or more of the above factors. Also (or instead), the particular value used as the error indicating value may also vary depending on any of these factors.

There are multiple operations which, when performed on an address operand, could inadvertently lead to the tag portion of the operand being modified. One example could be a logical “OR” operation. In another example, the operation comprises an arithmetic operation.

As noted above, some implementations may, in at least some modes of operation, treat any arithmetic instruction (and/or any logical OR instruction) as a tag protecting (potentially with the exception of dedicated tag-setting instructions). Other implementations may include, in the ISA, a dedicated instruction encoding for tag protecting arithmetic instructions.

In some examples, the arithmetic operation comprises an operation involving addition, and the processing circuitry is configured to detect, as the attempt to set the value of at least one bit in the identified portion of the output value to the value other than the value in the corresponding bit position in the input operand, that a carry value generated during the addition comprises a non-zero value in the corresponding bit position.

The arithmetic operation may be performed in response to an ADD instruction, or it may be performed as part of an arithmetic operation executed in response to some other arithmetic instruction (e.g. a subtract, multiply or divide instruction, each of which can be executed using addition). When performing an addition operation where one addend is an address pointer, even if the other addend only has zeroes in a portion aligning with the tag portion of the address pointer (e.g. even if the addition is not intended to modify the tag portion), a carry value generated during the addition may overflow into a bit position corresponding to the tag portion (e.g. it may overflow into the identified portion of the output value). Hence, it can be possible to inadvertently modify the identified portion of the output operand. The present technique provides protection against this kind of inadvertent modification of the identified portion, in addition to protecting against deliberate (e.g. malicious) attempts to modify the identified portion.

In some examples, the processing circuitry is responsive to a further tag protecting instruction identifying, as a further input operand, the output value obtained from the tag protecting instruction, to perform a further operation in respect of the output value to generate a further output value. In these examples, the processing circuitry is configured to detect whether the output value comprises the error-indicating value, and the processing circuitry is configured to perform, in response to detecting that the output value comprises the error-indicating value, an error response.

In this way, the error indicating value is propagated to the further output value. This makes it more difficult for the error-indicating value to be removed by performing a further operation on the output value, and hence further improves the security of the apparatus.

### Implementing Memory Tagging

The particular form of the generated indication of whether a match is detected between the guard tag and the address tag may vary from implementation to implementation. In some cases, the tag-guarded memory access operation may comprise controlling whether a memory access to the addressed location is allowed depending on whether the match is detected between the guard tag and the address tag. However, in other examples the tag-guarded memory access may comprise performing a memory access to the addressed location irrespective of whether a match is detected between the guard tag and the address tag. For example, the guard tag associated with a given block of memory locations may be stored in a different block of memory locations within the memory system and so accessing the guard tag may require a separate read operation. Therefore, it may delay processing of the actual memory access if the memory access is delayed until the guard tag and the address tag have been compared, so it may be desired to perform the memory access to the addressed location before the guard tag is available, and regardless of whether any match is detected between the guard tag and the address tag, and then to generate a separate indication of whether a match is detected once the guard tag has been obtained and compared with the address tag.

In one example the indication of whether a match is detected may be a signal representing a fault condition, which is generated when a mismatch is detected between the guard tag and the address tag. For example, the memory access circuitry may signal a similar memory fault to faults generated if access permissions are violated or unmapped addresses are accessed, or a different kind of fault condition could be indicated. The fault signal could trigger the processing circuitry to execute an exception handling routine for responding to the detected fault.

Alternatively, status indication may be recorded within a control register accessible to the processing circuitry of the apparatus, to indicate whether a match or mismatch was detected in the comparison of the guard tag and the address tag. The status information could then be read by subsequent instructions to check whether the memory access was valid.

Another option for reporting whether the address tag and guard tag matched or mismatched can be to record information in an error log associated with the executed piece of code, which tracks any guard tag errors detected throughout the piece of code. For example, in response to a mismatching guard tag and address tag, the target address which triggered the mismatch, or the instruction address of the instruction which triggered the mismatching memory access, could be recorded in the error log. In this case, rather than performing any specific action to impede the operation of the code, the errors could simply be recorded in the error log. The error log could then be made available to a software provider of the code to assist the provider with eliminating errors in subsequent versions of the software.

Hence, it will be appreciated that there are a range of ways in which the guard tag match/mismatch indication could be generated by the memory access circuitry.

In some embodiments, the blocks of memory locations which have corresponding guard tags may each comprise a single memory location. In this case, each individual memory location may have a different guard tag, which can provide fine granularity of setting the guard tags so that a greater range of memory errors can be detected.

However, in practise the overhead of setting individual guard tags for each addressed location may be too high, and it can be more efficient to associate each guard tag with a block of multiple memory locations. In this case several adjacent memory locations may share the same guard tag, which can be enough for detecting common forms of memory-related error.

The guard tag which is associated with a given block of memory locations can be stored at any other memory location within the memory system. The particular way in which the location of the guard tags in the memory system is selected may vary significantly from implementation to implementation or at run time. In some examples, the location storing the guard tags could be architecturally accessible by the processing circuitry, i.e. the guard tag storage location may be a location mapped to part of the same address space as the addressed location. In this case, the mapping between the addressed location itself and the address of the corresponding tag storage location could be fixed or hardwired, or could be variable, e.g. tracked in a tracking table maintained by the memory access circuitry or in a translation lookaside buffer. Alternatively, other implementations may store the guard tag associated with a given addressed location in a further storage location which is not architecturally accessible to the processing circuitry, e.g. in additional storage provided in the micro-architecture which is not mapped to the address space which can be addressed by instructions executed by the processing circuitry. In this case, the memory access circuitry may determine, based on the address of the addressed location, the particular internal address used to refer to the corresponding tag storage location, and trigger any additional memory access needed to read the tag data from the tag storage location. Regardless of whether or not the tag storage location is architecturally accessible to the processing circuitry, tag values could also be cached within a cache for faster access, either within the same cache used for data values, or in a dedicated tag cache.

The address tag can be associated with the target address in different ways. In some cases the address tag could be specified separately from the target address, e.g. using a separate register specified by the tag-guarded memory access instruction which triggers the tag-guarded memory access operation. However, in other examples the address tag may be determined as a function of one or more selected bits of the target address. That is, the address tag may comprise information derived from a portion of the target address itself. Often, while an instruction set architecture may support addresses with a certain number of bits (e.g. 64 bits), a given hardware device may not in practice need so much memory capacity that it would use all the possible addresses which can be represented using that number of bits. For example, with current trends in device usage there is not yet any need to provide 264 individual addressable locations. Therefore, often some bits of the memory addresses may effectively be unused and may either always have the same value, or be set as a sign extension of the most significant “real” address bit (so that the unused portion is set to all 0s or all 1s). This unused portion can therefore be reused to represent the address tag or a value for deriving the address tag, to avoid needing to access a separate register in order to obtain the address tag, and also to make it easier to track the correspondence between the addresses and the corresponding address tags as the address tag may by definition be transported along with the address whenever the address is manipulated or moves between registers.

In embodiments which use a portion of the target address to determine the address tag, note that this address tag is different to a tag portion of the target address which may be used by caches to determine whether the information from the addressed location identified by the target address is stored within the cache. Many caching schemes may store a tag portion of the address of a cached piece of data alongside that data within the cache, so that on searching the cache for a given address, part of the address can be compared with the tags stored alongside the cached data in order to determine whether the cached data actually corresponds to the required address. However, in this case the tag portion of the address, which is compared with the tag in the cache would be part of the portion of the address which actually identifies the particular addressed location for which the data is required, i.e. changing the cache tag portion of an address would by definition result in the address pointing to a different addressed location within the memory system. In contrast, with the address tag used for the tag-guarded memory operation, the memory access circuitry may select the addressed location for which data is required independent of the address tag. That is, even if the address tag has different values, the addressed location referenced by the target address may still be the same as the selection of the addressed location depends only on other portions of the target address. This gives the freedom for compilers to set the address tags associated with particular addresses to any value to match the corresponding guard tag values which have been allocated to the relevant blocks of data in the memory system.

In some implementations, the instruction decoder could support separate non-tag-guarded and tag-guarded variants of memory access instructions. In this case, the tag-guarded memory access operation could be triggered in response to the tag-guarded variant of the memory access instruction. In contrast non-tag-guarded memory access instructions could simply trigger an access to the addressed location identified by the target address specified by that instruction, without needing to obtain a guard tag or perform any comparison between the address tag and the guard tag.

However, in other implementations all memory accesses may be considered to be tag-guarded memory accesses. Hence, in some cases any memory access instruction may be considered to trigger the memory access circuitry to perform a tag-guarded memory access operation as discussed above.

However, even if all memory access instructions are interpreted as tag-guarded memory access instructions, there may still be other ways in which the instruction set architecture may support selectively disabling the guard tag comparison for certain operations. For example, a control parameter within a control register of the processing apparatus could selectively disable tag comparisons. Another option is for a certain value of the address tag to be interpreted in a special manner so that they indicate that the address tag should be considered to match against any possible value of the guard tag, again effectively disabling the effects of the tag comparison so that no error is reported regardless of whether the address tag matches the guard tag.

### Simulator Implementation

The techniques discussed above can be implemented in a hardware apparatus which has circuit hardware implementing the processing circuitry and access control circuitry described above, which support the tag protecting instruction and memory access instruction as part of the native instruction set architecture supported by the decode circuitry and processing circuitry.

However, in another example the same techniques may be implemented in a computer program (e.g. an architecture simulator or model) which may be provided for controlling a host data processing apparatus to provide an instruction execution environment for execution of instructions from target code. The computer program may include processing program logic for controlling a host data processing apparatus to perform data processing. Also, the program may include access control program logic to emulate the functionality of the access control circuitry described above. Hence, the processing program logic emulates the functionality of the processing circuitry of a hardware apparatus as discussed above. The processing program logic includes support for the tag protecting instruction which has the same functionality as described above for the hardware example. Hence, such a simulator computer program may present, to target code executing on the simulator computer program, a similar instruction execution environment to that which would be provided by an actual hardware apparatus capable of directly executing the target instruction set, even though there may not be any actual hardware providing these features in the host computer which is executing the simulator program. This can be useful for executing code written for one instruction set architecture on a host platform which does not actually support that architecture. Also, the simulator can be useful during development of software for a new version of an instruction set architecture while software development is being performed in parallel with development of hardware devices supporting the new architecture. This can allow software to be developed and tested on the simulator so that software development can start before the hardware devices supporting the new architecture are available.

### RTL/EDA Implementation

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may be define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may embody computer-readable representations of one or more netlists. The one or more netlists may be generated by applying one or more logic synthesis processes to an RTL representation. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Particular embodiments will now be described with reference to the figures.

### Example Data Processing Apparatus

FIG. 1 schematically illustrates an example of a data processing apparatus 2. It will be appreciated that this is simply a high level representation of a subset of components of the apparatus and the apparatus may include many other components not illustrated. The apparatus 2 comprises processing circuitry 4 for performing data processing in response to instructions decoded by an instruction decoder 6. The instruction decoder 6 decodes instructions fetched from an instruction cache 8 to generate control signals 10 for controlling the processing circuitry 4 to perform corresponding processing operations represented by the instructions. The processing circuitry 4 may include one or more execution units for performing operations on values stored in registers 14 to generate result values to be written back to the registers. For example the execution units could include an arithmetic/logic unit (ALU) for executing arithmetic operations or logical operations, a floating-point unit for executing operations using floating-point operands and/or a vector processing unit for performing vector operations on operands including multiple independent data elements. The processing circuitry also includes a memory access unit (or load/store unit) 15 for controlling transfer of data between the registers 14 and the memory system. In this example, the memory system includes the instruction cache 8, a level 1 data cache 16, a level 2 cache 17 shared between data and instructions, and main memory 18. It will be appreciated that other cache hierarchies are also possible—this is just one example. A memory management unit (MMU) 20 is provided for providing address translation functionality to support memory accesses triggered by the load/store unit 15. The MMU has a translation lookaside buffer (TLB) 22 for caching a subset of entries from page table stored in the memory system 16, 17, 18. Each page table entry may provide an address translation mapping for a corresponding page of addresses and may also specify access control parameters, such as access permissions specifying whether the page is a read only region or is both readable and writable, or access permissions specifying which privilege levels can access the page.

In FIG. 1, the processing circuitry 4 is an example of processing circuitry to perform data processing operations in response to instructions, wherein the processing circuitry is responsive to a memory access instruction identifying an address pointer to issue a memory access request comprising a request to access data stored at a memory location identified by a memory address determined based on an address portion of the address pointer. The load/store unit (memory access circuitry) 15, meanwhile, is an example of access control circuitry responsive to the memory access request to compare a tag value determined based on a tag portion of the address pointer with an allocation tag associated with the memory location identified by the memory address and, in response to the comparison indicating a given result, to perform a tag error response.

### Memory Tagging

FIG. 2 schematically illustrates a concept of tag-guarded memory accesses. The physical address space used to refer to memory locations within the memory system may be logically partitioned into a number of blocks 30 each comprising a certain number of addressable locations. For conciseness, in the example of FIG. 2, each block 30 comprises four memory locations, but other block sizes could be used as well. Each block 30 is associated with a corresponding guard tag 32. The guard tags associated with a certain number of blocks 30 can be gathered together and stored either within a different architecturally accessible memory location 34 within the physical address space, or within additional storage locations provided in main memory 18 which are not architecturally accessible (not mapped to the same physical address space). The use of separate non-architecturally accessible storage may in some cases be preferred to avoid using up space in the data caches 16, 17 for caching guard tag values, which could impact on the performance of the regular code and could make coherency management more complex. An additional tag cache 19 could be provided in the micro architecture for caching tag values from the non-architecturally accessible storage, for faster access than if the tags had to be accessed from main memory 18. The particular mapping of which tag storage locations 34 correspond to each block 30 may be controlled by the load/store unit 15 and could be hardwired or could be programmable. While in FIG. 2 each tag 32 is associated with a block of physical addresses, it would also be possible to provide guard tags 32 associated with virtual memory locations in a virtual memory address space, but this may require some additional address translations on each memory access. Hence by associating the guard tag 32 with physical memory locations this can improve performance. In general it is a choice for the particular micro architectural implementation exactly how the guard tags 32 are associated with the corresponding blocks 30 of the physical address space. In general, all that is required is that the guard tag 32 associated with a given block of memory can be accessed and compared.

Hence, when a tag-guarded memory access is required, an address tag 40 (which is associated with the target address 42 identifying the addressed location 44 to be accessed), is compared against the guard tag 32 which is associated with the block of memory locations 30 which includes the addressed location 44. For example, in FIG. 2 the target address 42 points to a certain location B1 in memory, marked 44 in the address space of FIG. 2. Therefore the guard tag B which is associated with the block of locations B including location B1 is compared against the address tag 40 associated with a target address 42. As shown in the top of FIG. 2, the address tag 40 may be determined as a function of selected bits of the target address itself. In particular, the address tag may be determined from bits within a portion of the target address which is unused for indicating the specific memory location which is to be selected as the addressed location 44. For example, in some architectures the top portion of bits of the target address may always have a certain fixed value such as a sign extension (all 0s or all 1s) and so an address can be tagged with the address tag 40 by overwriting these unused bits with an arbitrary tag value. The particular address tag value can be selected by a programmer or compiler for example. The address tag and guard tag 32 can be a relatively small number of bits, e.g. 4 bits, and so need not occupy much space within the memory and within the target address. Providing 4 bits of tag space, i.e. 16 possible values of the tags, can often be enough to detect many common types of memory access errors.

Hence, when a tag-guarded memory access is performed, the load/store unit 15 compares the address tag 40 and the guard tag 32 associated with a block 30 including the addressed location 44, and determines whether they match. The load/store unit 15 generates a match indication indicating whether the address tag 40 and the guard tag 32 matched. For example, this match indication could be a fault signal 60 which is generated if there is a mismatch between the address tag 40 and the guard tag 32, or an indication placed in a status register indicating whether there was a match, or an entry added to an error report to indicate the address for which the error was detected and/or the instruction address of the instruction which triggered the error.

FIG. 3 shows a flow diagram for handling a tag guarded memory access. The instruction triggering the memory access may specify an address tag and a target address. As shown in FIG. 2, in some cases the address tag may actually be derived from a subset of bits of the target address itself, although in other examples it could be specified in a separate register. At step 50, the instruction triggering the tag guarded memory accesses is encountered. In response, at step 52 the memory access circuitry 15 triggers a memory access to the addressed location 44 identified by the target address. Also, at step 54 the memory access circuitry 15 obtains the guard tag 32 which is stored in the memory system in association with the block of memory locations 30 that includes the addressed location 44 identified by the target address. At step 56 the memory access circuitry 15 compares the address tag 40 with the guard tag 32 obtained at step 54. At step 58 an indication of whether a match is detected between the guard tag and the address tag is generated by the memory access circuitry 15 (e.g. any of the types of match/mismatch reporting indication described above). The precise indication used to report any mismatch may vary from implementation to implementation.

### Tag Protecting Instruction

In a system implementing memory tagging, tagged pointers may be manipulated as integers, which can lead to the tag value being modified. Even if an operation only targets the non-tag part of the pointer, the tag may still inadvertently be affected by overflow from the operation. This unintentional modification of the tag can have a mild beneficial effect in terms of, for example, highlighting errors in operations performed on address pointers, but it also reduces the security benefits of such a system by potentially making it possible for an attacker to manipulate the tag value. In many systems, this reduction in security outweighs the mild benefits that might be provided.

An example of an operation that might involve manipulating an address pointer is a pointer arithmetic operation, where the pointer is specified as an input operand for an arithmetic (e.g. add, subtract, multiply, divide, etc.) operation. Note that, while the term “pointer arithmetic” is used here, the processing circuitry is typically agnostic as to the meaning of the operands used for a given operation—i.e., a “pointer arithmetic” operation is, to the processing circuitry, just an arithmetic operation, and the address pointer(s) specified as input operands are, to the processing circuitry, just input operands.

Most arithmetic operations performed by the processing circuitry involve addition (for example, even a subtract, multiple or divide operation can be represented using one or more addition operations). The processing circuitry may comprise an arithmetic logic unit (ALU) for performing arithmetic operations, and the ALU may comprise ADD circuitry to perform addition operations. An example of an addition operation is shown in FIG. 4.

FIG. 4 illustrates the addition of two three-bit binary addends 62: 0b100+0b111 (note that the prefix “0b.” is used here to indicate that the following value is a binary value—the value 0b100 is represented as “4” in decimal, and the value 0b111 is “7” in decimal). As shown in FIG. 4, even though both of the addends are three-bit values, the addition generates a carry value 64 which has a non-zero value (a “1” in this case) in a more-significant bit position (i.e. the carry value is a 4-bit value 0b1000)—this is because when the bits in the third-least-significant position 66 are added together (0b1+0b1) the result is a two-bit value (0b10), and so the “1” carries over to the next-most-significant bit position. This means that the result value 68 is a 4-bit value (0b1011, which is “11” in decimal). Hence, a carry value generated during an addition operation can overflow into a more-significant bit position.

FIG. 5 illustrates how the generation of a carry value can lead to the modification of a tag in an address pointer. In particular, FIG. 5 represents an addition operation to add a value “Y” to an address pointer “X”, to generate an output “Z”. For example, Y could be an offset value being added to a base address represented by address pointer X-however, it will be appreciated that this is just one example of why an arithmetic operation may be performed on an address pointer.

As shown in FIG. 5, the address pointer X and the other addend Y both have a value of “1” in position 70 corresponding to a most-significant bit of an address portion 72 of pointer X. This means that, when the addends X and Y are added together, a carry value is generated which overflows into a portion 74 of the result value Z that would be the tag portion 40 if Z were used as an address pointer. (Note that this is not the only way such a carry value can be generated—i.e. it is not essential for bit 70 to be “1” in both addends).

Accordingly, even if the addend Z comprises no non-zero values in a portion 74 corresponding to the tag portion 40 of address pointer Y, a carry value generated during the addition may still lead to the corresponding portion 74 in the output value Z differing from the tag portion 40 in the input address pointer Y. As discussed above, this could lead to a reduction in security.

Note that, whilst an arithmetic operation is one example of a pointer manipulation operation, other operations may also be applied to address pointers, and may also cause the tag portion to be modified. For example, a logical “OR” operation may be performed in respect of a value that might later be used as an address pointer, and such an operation may also modify the tag. For example, two operands may have a tag portions that read:

$$0 b 1010$$

$$0 b 0001$$

If logical OR is performed on these two operands, the tag portion of the output value would read:

$$0 b 1011$$

Hence, the tag portion of the output value is, in this case, different to the tag portions of both of the input operands.

To prevent the security risk that comes with allowing the tag portions of operands to be modified, one may consider providing instructions which operate only on address portion of a pointer, thus avoiding the tag modification. For example, the operand Y in FIG. 5 could be carefully selected such that it will not cause an overflow into the portion 74 of the result. In such a system, any attempt to set the portion 74 (i.e. a portion which would be the tag portion if the result value Z were used as an address pointer) can usually be assumed to be an error, and hence may trigger an error response.

There are several possibilities for responding to such an error. For example, one possibility is simply to ignore the error. This limits the overhead involved in implementing the pointer manipulation operation, but does not address the security concerns associated with the modification to the tag portion.

Another potential response is to raise a processor exception. However, raising a processor exception can incur a significant reduction in performance, which may not be warranted in this situation since the result of the operation may only go on to be used as an address pointer in a small number of cases.

Another potential response is to record information about the error to a status register—for example, the contents of this register may be used in debugging. This incurs less of a performance cost than raising a processor exception, but still can lead to a “false positive” result (where an error is recorded even though the result value is never used as an address pointer).

An improved approach is to modify the output value Z such that a subsequent use of the modified value Z′ as an address pointer triggers an error response. For example, the processor circuitry detects the overflow into the region 74 that corresponds to the tag portion, and in response to this detection generates a modified result value Z′ that includes some error indicating value. The error indicating value is a value that causes the value Z′ to be treated as invalid if it is subsequently used as an address pointer.

FIG. 6 illustrates examples of invalid pointers—the modified result value Z′ may, for example, be set such that it is invalid in one of the ways illustrates in this figure.

FIG. 6 illustrates an example where an address pointer comprises 64 bits. In a valid address pointer 78 these bits may be interpreted as follows:
the bottom (least-significant) 56 bits (bits 55:0) may be interpreted as address bits—these are the bits which identify a location in memory;
bits 59:56 represent a 4-bit address tag; and
the top 4 bits (bits 63:60) may be spare bits and/or bits used to provide some other information.

The processing circuitry may modify a value in any of a number of different ways, to make it represent an invalid address pointer. For example, some implementations of the present technique could make use of some of the top bits, and set these to some specific value to indicate that the pointer is invalid—for example, FIG. 6 shows an example of an invalid pointer 80 where the bits 61:60 have been set to a value of 0b01. (It will be appreciated that a value of 0b01 for these bits is used as an example—the exact value used as the error indicating value may be implementation-dependent).

In some example implementations, the tag bits may be set to some specific value to indicate that the pointer is invalid. For example, certain tag values could be reserved for indicating errors, and hence the tag value may be set to one of those values. For example, FIG. 6 shows an example of an invalid pointer 82 where the tag portion has been set to a value of 0b1110. (Again, this is just one example of a value that could be used as an error indicating value).

In some example implementations, if not all of the address bits are needed to define addressable memory, the address portion could be set to some non-canonical value (e.g. an address which is guaranteed to cause a fault if accessed). As a particular example, FIG. 6 shows an invalid pointer 84 where the address bits have all been set to zero. Again, this is just one example of a value that could be used as an error indicating value—while it is fairly common to reserve this address value for providing some alternative information (e.g. indicating an error, as in this example), other implementations may use a different address value as an error indicating value).

Note that the particular values used in FIG. 6 as the error generating values are just examples, and the specific values used may depend on the specific architecture used by the system. Moreover, note that some implementations may use some combination of these techniques to force the pointer to an invalid value.

FIG. 7 is a flow diagram illustrating an example of a method which may be performed by the processing circuitry in response to decoding 86 a tag protecting instruction. The tag protecting instruction identifies an input operand, and the processing circuitry responds to the instruction being decoded by performing 88 an operation, in respect of the input operand, to generate an output value. As discussed above, this operation could—for example—be an arithmetic operation; however, it will be appreciated that the operation performed in responds to the tag protecting instruction could be any operation which has the potential to modify the tag portion of an address pointer.

The processing circuitry also detects 90 whether the operation performed on the input operand involved an attempt to set the value of at least one bit in an identified portion of the output value to a value other than a value in a corresponding bit position in the input operand, where the identified portion is a portion of the output value which would be used as the tag portion if the input operand was used as the address pointer for the memory access instruction. If it is determined that such an attempt was not (N) made, the output operand is return 92 (e.g. it may be recorded in a register) without being modified. On the other hand, if it is determined that such an attempt was (Y) made, the processing circuitry sets 94 at least a given portion of the output value to an error-indicating value, before returning 96 the modified output value.

FIG. 8 is a flow diagram illustrating an example of a method performed by access control circuitry in response to a memory access instruction being decoded 98. The access control circuitry is configured, when a memory access instruction is decoded, to determine 100 whether an address pointer identified by the memory access instruction is valid. If the pointer is invalid, a pointer error response is performed 102. For example, the error response could comprise raising an exception or recording a value to a status register. In some cases, after performing 102 the error response (e.g. if the response is to record a value to a status register), the method continues to step 104. On the other hand, the error response may be performed instead of performing steps 104, 103, 105 and 106—for example, raising an exception may halt processing.

The method of FIG. 8 also comprises determining 104 a memory address based on the address pointer identified by the memory access instruction. Note that, while this example only performs step 104 when the address pointer is determined 100 to be valid (Y), it is also possible in alternative implementations to perform step 104 before checking 100 whether the address pointer is valid.

The method also comprises a step 103 of comparing a tag value (address tag) determined based on a tag portion of the address pointer with an allocation tag (guard tag) associated with a memory location identified by the determined memory address, and determining whether the comparison indicates a given result. When (Y) the comparison indicates the given response, a tag error response is performed 105 (e.g. this could be the same as or different from the error response indicated above). On the other hand, when (N) it is determined that the comparison does not indicate the given result, the requested data access is performed 105 (subject to any other access requirements being satisfied).

### Simulator Implementation

FIG. 9 illustrates a simulator implementation that may be used. Whilst the earlier described embodiments implement the present invention in terms of apparatus and methods for operating specific processing hardware supporting the techniques concerned, it is also possible to provide an instruction execution environment in accordance with the embodiments described herein which is implemented through the use of a computer program. Such computer programs are often referred to as simulators, insofar as they provide a software based implementation of a hardware architecture. Varieties of simulator computer programs include emulators, virtual machines, models, and binary translators, including dynamic binary translators.

Typically, a simulator implementation may run on a host processor 730, optionally running a host operating system 720, supporting the simulator program 710. In some arrangements, there may be multiple layers of simulation between the hardware and the provided instruction execution environment, and/or multiple distinct instruction execution environments provided on the same host processor. Historically, powerful processors have been required to provide simulator implementations which execute at a reasonable speed, but such an approach may be justified in certain circumstances, such as when there is a desire to run code native to another processor for compatibility or re-use reasons. For example, the simulator implementation may provide an instruction execution environment with additional functionality which is not supported by the host processor hardware, or provide an instruction execution environment typically associated with a different hardware architecture. An overview of simulation is given in “Some Efficient Architecture Simulation Techniques”, Robert Bedichek, Winter 1990 USENIX Conference, Pages 53-63.

To the extent that embodiments have previously been described with reference to particular hardware constructs or features, in a simulated embodiment, equivalent functionality may be provided by suitable software constructs or features. For example, particular circuitry may be implemented in a simulated embodiment as computer program logic. Similarly, memory hardware, such as a register or cache, may be implemented in a simulated embodiment as a software data structure. In arrangements where one or more of the hardware elements referenced in the previously described embodiments are present on the host hardware (for example, host processor 730), some simulated embodiments may make use of the host hardware, where suitable.

For example, the simulator code 710 may include instruction decoding program logic 712 to decode instructions in the target code-hence, the instruction decoding program logic may emulate the instruction decoder 6 described earlier. The simulator code 710 may also include register emulating program logic to emulate the registers 14 described above. The simulator program also includes processing program logic 716 to process instructions in the target code 700 (end hence emulate processing circuitry 4) as well as access control program logic 718 to emulate access control circuitry such as the MMU 20.

The simulator program 710 may be stored on a computer-readable storage medium (which may be a non-transitory medium), and provides a program interface (instruction execution environment) to the target code 700 (which may include applications, operating systems and a hypervisor) which is the same as the interface of the hardware architecture being modelled by the simulator program 710. Thus, the program instructions of the target code 700, including the memory access instruction and tag protecting instruction described above, may be executed from within the instruction execution environment using the simulator program 710, so that a host computer 730 which does not actually have the hardware features of the apparatus 2 discussed above can emulate these features.

Accordingly, the simulator code 710 is an example of a computer program comprising instructions which, when executed by a host data processing apparatus, control the host data processing apparatus to provide an instruction execution environment for executing target program code, the computer program comprising:
processing program logic to perform data processing operations in response to instructions in the target program code, wherein the processing program logic is responsive to a memory access instruction identifying an address pointer to issue a memory access request comprising a request to access data stored at a memory location identified by a memory address determined based on an address portion of the address pointer; and
access control program logic responsive to the memory access request to compare a tag value determined based on a tag portion of the address pointer with an allocation tag associated with the memory location identified by the memory address and, in response to the comparison indicating a given result, to perform a tag error response, wherein:
the processing program logic is responsive to a tag protecting instruction identifying an input operand to perform an operation in respect of the input operand to generate an output value;
the processing program logic is configured to detect whether the operation involved an attempt to set the value of at least one bit in an identified portion of the output value to a value other than a value in a corresponding bit position in the input operand;
the processing program logic is configured to set, in response to detecting that the operation involved the attempt to set the value of at least one bit in the identified portion of the output value to the value other than the value in a corresponding bit position in the input operand, at least a given portion of the output value to an error-indicating value; and
the identified portion is a portion of the output value which would be used as the tag portion if the output operand was used as the address pointer for the memory access instruction.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Further, the words “comprising at least one of . . . ” in the present application are used to mean that any one of the following options or any combination of the following options is included. For example, “at least one of: A; B and C” is intended to mean A or B or C or any combination of A, B and C (e.g. A and B or A and C or B and C).

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry to perform data processing operations in response to instructions,
wherein the processing circuitry is responsive to a memory access instruction identifying an address pointer to issue a memory access request comprising a request to access data stored at a memory location identified by a memory address determined based on an address portion of the address pointer; and
access control circuitry responsive to the memory access request to compare a tag value determined based on a tag portion of the address pointer with an allocation tag associated with the memory location identified by the memory address and, in response to the comparison indicating a given result, to perform a tag error response,
wherein:
the processing circuitry is responsive to a tag protecting instruction identifying an input operand to perform an operation in respect of the input operand to generate an output value;
the processing circuitry is configured to detect whether the operation involved an attempt to set the value of at least one bit in an identified portion of the output value to a value other than a value in a corresponding bit position in the input operand;
the processing circuitry is configured to set, in response to detecting that the operation involved the attempt to set the value of at least one bit in the identified portion of the output value to the value other than the value in a corresponding bit position in the input operand, at least a given portion of the output value to an error-indicating value; and
the identified portion is a portion of the output value which would be used as the tag portion if the output operand was used as the address pointer for the memory access instruction.

2. The apparatus of claim 1, wherein
the access control circuitry is responsive to the memory access instruction identifying, as the address pointer, an operand comprising the error-indicating value to trigger a pointer error response.

3. The apparatus of claim 2, wherein
the processing circuitry is configured to detect whether the operand identified by the memory access instruction comprises the error-indicating value in dependence on at least one of:
a current mode of operation of the processing circuitry;
the operand; and
a value generated using at least part of the operand.

4. The apparatus of claim 2, wherein
the pointer error response comprises at least one of:
generating an exception; and
recording an error indication in a status register.

5. The apparatus of claim 1, wherein:
the given portion comprises the identified portion.

6. The apparatus of claim 1, wherein:
the given portion comprises an address-identifying portion; and
the processing circuitry is responsive to the memory access instruction identifying, as the address pointer, the output value to treat the address-identifying portion of the output value as the address portion.

7. The apparatus of claim 1, wherein
the given portion of the output address pointer comprises an error indicating field of the output value.

8. The apparatus of claim 1, wherein:
the processing circuitry is configured to set the value of the given portion of the output value in dependence on at least one of:
a current mode of operation of the processing circuitry;
the input operand; and
the output value.

9. The apparatus of claim 1, wherein:
the operation comprises an arithmetic operation.

10. The apparatus of claim 9, wherein:
the arithmetic operation comprises an operation involving addition; and
the processing circuitry is configured to detect, as the attempt to set the value of at least one bit in the identified portion of the output value to the value other than the value in the corresponding bit position in the input operand, that a carry value generated during the addition comprises a non-zero value in the corresponding bit position.

11. The apparatus of claim 1, wherein:
the processing circuitry is responsive to a further tag protecting instruction identifying, as a further input operand, the output value obtained from the tag protecting instruction, to perform a further operation in respect of the output value to generate a further output value;
the processing circuitry is configured to detect whether the output value comprises the error-indicating value; and
the processing circuitry is configured to perform, in response to detecting that the output value comprises the error-indicating value, an error response.

12. A method comprising:
performing data processing operations in response to instructions,
in response to a memory access instruction identifying an address pointer, issuing a memory access request comprising a request to access data stored at a memory location identified by a memory address determined based on an address portion of the address pointer;
in response to the memory access request, comparing a tag value determined based on a tag portion of the address pointer with an allocation tag associated with the memory location identified by the memory address and, in response to the comparison indicating a given result, performing a tag error response;
in response to a tag protecting instruction identifying an input operand, performing an operation in respect of the input operand to generate an output value; detecting whether the operation involved an attempt to set the value of at least one bit in an identified portion of the output value to a value other than a value in a corresponding bit position in the input operand; and
in response to detecting that the operation involved the attempt to set the value of at least one bit in the identified portion of the output value to the value other than the value in a corresponding bit position in the input operand, setting at least a given portion of the output value to an error-indicating value,
wherein the identified portion is a portion of the output value which would be used as the tag portion if the output operand was used as the address pointer for the memory access instruction.

13. A computer program comprising instructions which, when executed by a host data processing apparatus, control the host data processing apparatus to provide an instruction execution environment for executing target program code, the computer program comprising:
processing program logic to perform data processing operations in response to instructions in the target program code,
wherein the processing program logic is responsive to a memory access instruction identifying an address pointer to issue a memory access request comprising a request to access data stored at a memory location identified by a memory address determined based on an address portion of the address pointer; and
access control program logic responsive to the memory access request to compare a tag value determined based on a tag portion of the address pointer with an allocation tag associated with the memory location identified by the memory address and, in response to the comparison indicating a given result, to perform a tag error response,
wherein:
the processing program logic is responsive to a tag protecting instruction identifying an input operand to perform an operation in respect of the input operand to generate an output value;
the processing program logic is configured to detect whether the operation involved an attempt to set the value of at least one bit in an identified portion of the output value to a value other than a value in a corresponding bit position in the input operand;
the processing program logic is configured to set, in response to detecting that the operation involved the attempt to set the value of at least one bit in the identified portion of the output value to the value other than the value in a corresponding bit position in the input operand, at least a given portion of the output value to an error-indicating value; and
the identified portion is a portion of the output value which would be used as the tag portion if the output operand was used as the address pointer for the memory access instruction.

14. A computer-readable storage medium to store the computer program of claim 13.

15. A computer-readable medium to store computer-readable code for fabrication of the apparatus of claim 1.
